(19) United States
(12) Patent Application Publication
(10) Pub. No.: US 2009/0210514 A1
(43) Pub. Date: Aug. 20, 2009

(54) METHODS, APPARATUSES, COMPUTER PROGRAM PRODUCTS, AND SYSTEMS FOR MOBILE WEB BROWSING

(75) Inventors: Franklin Davis, Newton, MA (US); Guido Grassel, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/032,360

(22) Filed: Feb. 15, 2008

(51) Int. Cl. G06F 15/16

(52) U.S. Cl. 709/219

(57) ABSTRACT

An apparatus for delivering web content to a mobile device may include a processor. The processor may be configured to determine whether a web page may be adapted or should be viewed in its original form, transcode the original web page to generate a transcoded version of the web page if it is determined that the web page may be adapted, and to send data comprising either the original web page of the transcoded version to a remote device. Users may request a different version than the processor's initial determination, and an aggregation of such user preferences may be used to make a better determination of what version to send by default to all users. Corresponding methods, computer program products, and systems are also provided.

### TECHNOLOGICAL FIELD

Embodiments of the present invention relate generally to mobile communication technology and, more particularly, relate to methods, apparatuses, computer program products, and systems for delivering web pages to mobile devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

This explosive growth of mobile communications networks has allowed for widespread distribution of Internet content even to mobile devices in remote locations. However, one area in which there is a demand for further improvement is the delivery of web content to mobile devices over mobile networks in a functional form that is useful to a user of a mobile device while doing so with improved efficiency in terms of required network bandwidth and transmission time.

As mobile networking technologies have improved, so too have the mobile devices which communicate over mobile networks. Performance enhancements and continued miniaturization of central processing units (CPUs) and other components used in mobile devices in conjunction with improving mobile networks have allowed mobile devices to execute many of the functions traditionally limited to the realm of larger personal computing devices. One such function which is now commonly executed by mobile devices is web browsing.

However, the experience of mobile device users browsing the web on their mobile devices may not always be the best. Mobile networks often have less bandwidth and thus lower data transmission rates than the broadband connections many consumers are used to using on their desktop computers for browsing the web. Moreover, web browsing is some times inherently slowed when performed over mobile communications networks due to various adaptations which must occur to allow for HTTP communication over the protocols standard to some mobile networks. Thus, the slower data transmission rates of mobile networks present an inconvenience for users of mobile web browsers, who often face a noticeable delay between submitting a request to fetch a web page and display of the web page on their mobile device, especially for more complex web pages, which may contain several image files, Cascading Style Sheets (CSS), and dynamic HTML and JavaScript (also known as Ajax) elements, which are slow to load on mobile data networks because of high latency for each individual request. In addition to the frustration and inconvenience that the long delay between page request and display may incur, a user may also be faced with a potentially high cost for data consumed when downloading complex web pages to a device via network links that charge the user at a rate based upon the amount of data transferred.

Heretofore, a mobile device user has had several choices for browsing web pages on his mobile device. One option available to a mobile device user is to use a full web browser on the mobile device to directly fetch the original, full version of web pages. A full browser on a mobile device can display a web page similarly to a desktop browser with the exceptions of being slower as discussed above as well as the potential difficulties associated with viewing and interacting with the page on a device with a small screen and limited input methods. As it is a full web browser, the browser must necessarily fetch all of the original data comprising a web page, which may be quite large, often in excess of 512 KB, which includes all HTML, CSS, script, and image files comprising the web page. Thus using a full browser to view more complex web pages may often be slow and quite expensive in terms of both network usage and monetary cost to the user for data transfer and there is the potential that the full web page version may be cumbersome to view and interact with on a mobile device due to the small screen size and limited means of input. However, this may be the most feasible means for using many interactive web pages that depend on a full-featured web browser for their functionality.

A second option available to a mobile device user is to use a web browser or a wireless application protocol (WAP) browser on the device to fetch pages via an adaptation proxy, which transcodes the original HTML page to a simpler form of HTML with a goal of accelerating display of the page and reducing the size of the data that must be sent to a mobile device. The adaptation proxy may eliminate or reduce images, CSS styling, and interactive script. This elimination or reduction of some of the more complex and data intensive elements of the original web page may result in the transcoded version displayed on a mobile device having a much different appearance than the original web page displayed on a desktop browser. Generally, the rich, interactive features of the page are dropped and in some cases dropping these features may result in the transcoded version displayed on a mobile device being non-functional for a mobile device user. For example, the page may contain a form that uses JavaScript to check its values or to submit the form, and that function may not work on the transcoded page, making it impossible to submit the form. The page may have a sophisticated layout that is understandable when viewed in its original full mode, but becomes confusing when adapted by the server. Thus, while adapting web pages may result in decreased latency between the initial request to fetch a web page and subsequent display of the page by reducing the data that must be sent, frequently mobile device users may find that the adapted version displayed on their mobile device is not fully usable.

A third option currently available is to use a server-side browsing client that uses a server running a full web browser to perform the complex, data-intensive tasks of fetching and displaying a web page. After processing and rendering the page, the server sends the displayable results to a small client in the mobile device, resulting in faster display and smaller data size. However, with many server-side browsing clients, the user cannot use most rich interactive features that may be embedded in the web page because the client simply displays the results from the server-side browser. As such, the user may not be able to use interactive or dynamic features of a web page, such as rollover menus, dynamic forms, streaming media plug-ins, or interactive Ajax features of the page. As the client running in the device is only capable of simple display tasks, with many server-side browsing clients, the user has no possibility to request processing and rendering of the full web page on the mobile device so that he may use the interactive features. Thus, while the use of a server-side browsing client may provide a user with an excellent experience when viewing static pages, it is often inflexible because the actual browser is running on a server and thus the user may not have an alternative when wishing to view and interact with pages containing dynamic content and as such does not provide a viable solution to the aforementioned problems currently plaguing web browsing on mobile devices.

As such, it would be desirable for a mobile device web browser to fetch and display the original, full version of web pages only when necessary because of the complex layout of a page or dynamic features, the loss of which would render a transcoded version of the web page non-functional and otherwise to fetch and display a transcoded version when a page would remain viewable and functional in its adapted form. By switching between these two techniques, the data transmitted to the mobile device could be reduced and consequently the cost in terms of time, money, and network bandwidth could be similarly reduced. Today, however, there is not a convenient method for a user to switch between full browsing and viewing transcoded web pages via a proxy. Generally, the user must first browse to a proxy site on the web browser on his mobile terminal and then request a page to be transcoded. If, however, the user finds that the transcoded version of the web page layout displays poorly or that the loss of dynamic elements of the original web page has rendered the transcoded-version non-functional, the user must then manually request the browser to fetch the full version of the web page by directly entering the URL of the website in the browser, selecting a previously stored bookmark, or selecting a “view original version” link that may be inserted by the adaptation proxy server at the bottom of the page. The user is then faced with waiting an additional amount of time and perhaps being charged an additional sum of money for data transfer as two versions of the web page will have been fetched. As such, there is currently no automatic logical determination or foresight by either the mobile device or a remote adaptation proxy server of whether a web page needs to be displayed in its full version or may be transcoded and displayed in its adapted version to reduce the amount of data that must be transmitted over the mobile network. Sole discretion is in the hands of the mobile device user and acceptable results may only be obtained through sheer luck or by leveraging the user's experience if the user has previously fetched the particular web page and knows whether the page is viewable in its adapted form or must be viewed in its full form.

Accordingly, it would be advantageous to provide methods, apparatuses, computer program products, and systems that allow for the automated determination of whether a requested web page may be fetched in its reduced data size transcoded form or must be fetched in its full, original form without imposing any unnecessary decisional burden on mobile device users.

### BRIEF SUMMARY

A method, apparatus, computer program product, and system are therefore provided to improve the web browsing experience of mobile device users. In particular, a method, apparatus, computer program product, and system are provided to enable an automatic determination of whether a requested web page is functionally displayable in an adapted mobile-friendly form and as such should be transcoded by an adaptation proxy server or if it contains, for example, a complex layout or dynamic elements that would prevent an adapted version from being useable and as such should be fetched in its full, original form. Accordingly, users of mobile devices may request a web page and have an appropriate version intelligently fetched for them while saving time, money, and network bandwidth without the frustration and perils of currently available options that require mobile device users to manually determine whether to always fetch the full version or an adapted version of web pages and in some cases may result in a user who made a poor choice having to fetch both versions of a web page.

In one exemplary embodiment, a method is provided that may comprise determining whether a web page may be adapted or should be viewed in its original form, transcoding the original web page to generate a transcoded version of the web page if it is determined that the web page may be adapted, and sending data comprising either the original web page or the transcoded version to a remote device.

In another exemplary embodiment, a computer program product is provided that includes at least one computer-readable storage medium having computer-readable program code portions stored therein. The computer-readable program code portions include first, second, and third executable portions. The first executable portion is for determining whether a web page may be adapted or should be viewed in its original form. The second executable portion is for transcoding the original web page to generate a transcoded version of the web page if it is determined that the web page may be adapted. The third executable portion is for sending data comprising either the original web page or the transcoded version to a remote device.

In another exemplary embodiment, an apparatus for generating a digital media file from a source file is provided. The apparatus may include a processor. The processor may be configured to determine whether a web page may be adapted or should be viewed in its original form, transcode the original web page to generate a transcoded version of the web page if it is determined that the web page may be adapted, and send data comprising either the original web page or the transcoded version to a remote device.

In another exemplary embodiment, a system is provided comprising a computing device configured to receive a request for a web page from a remote device and to determine whether to send either the original web page or a transcoded version of the web page to the remote device. The computing device is further configured to transcode the original web page to generate a transcoded version of the web page if the computing device determines that a transcoded version of the web page may be sent to the remote device. The system of this embodiment also includes a device executing a web browser application configured to send a request for a web page to the computing device and to receive one or both of the original web page or the transcoded version of the web page.

In another exemplary embodiment, an apparatus is provided comprising means for determining whether a web page may be adapted or should be viewed in its original form, means for transcoding the original web page to generate a transcoded version of the web page if it is determined that the web page may be adapted, and means for sending data comprising either the original web page or the transcoded version to a remote device.

Embodiments of the invention may therefore provide a method, apparatus, computer program product, and system for receiving a request for a web page from a remote device, determining whether the web page may be adapted and if so sending a transcoded version to the remote device and if not sending the full original web page to the device. As such the web browsing experience of mobile terminal users may be vastly improved without imposing any burden on users to select whether to fetch an adapted version or the full version of a web page.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is an illustration of a standard full version of a web page;

FIG. 4 is an illustration of the same web page in an adapted form for display on a mobile device;

FIG. 5 illustrates a block diagram of an exemplary implementation of a system for delivering web content to a device in accordance with one embodiment of the present invention;

FIG. 6 is a flowchart illustrating the operations performed to deliver web content to a device in accordance with one embodiment of the present invention; and

FIG. 7 is a flowchart illustrating the operations performed to allow a user to request a web page be delivered in a specific mode and to aggregate user preferences in accordance with one embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

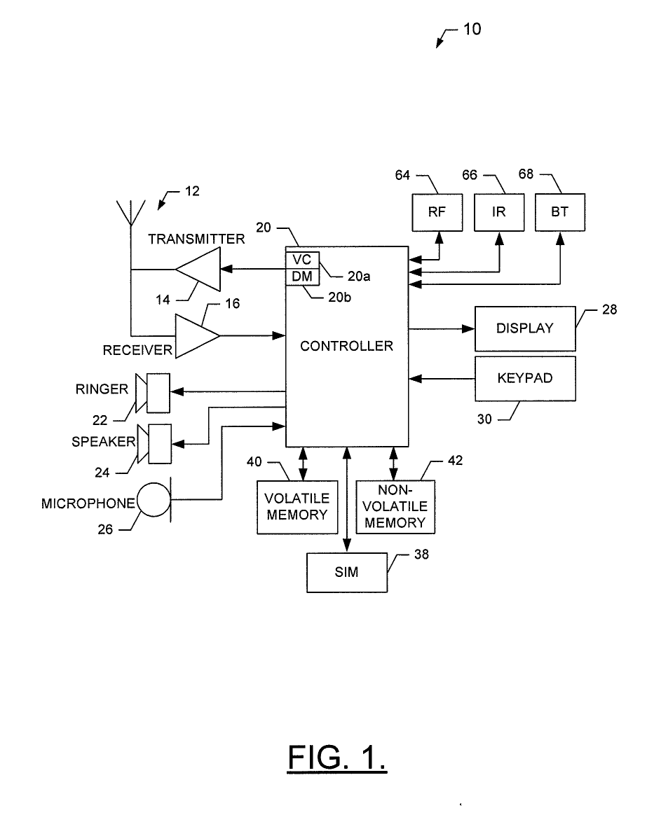

FIG. 1 illustrates a block diagram of a mobile terminal 10 that may benefit from embodiments of the present invention. It should be understood, however, that the mobile terminal illustrated and hereinafter described is merely illustrative of one type of electronic device that may benefit from the present invention and, therefore, should not be taken to limit the scope of the present invention. While several embodiments of the electronic device are illustrated and will be hereinafter described for purposes of example, other types of electronic devices, such as portable digital assistants (PDAs), pagers, laptop computers, desktop computers, gaming devices, televisions, and other types of electronic systems, may employ embodiments of the present invention.

As shown, the mobile terminal 10 includes an antenna 12 in communication with a transmitter 14, and a receiver 16. The mobile terminal also includes a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be capable of operating in accordance with 3G wireless communication protocols such as UMTS network employing WCDMA radio access technology. Some NAMPS, as well as TACS, mobile terminals may also benefit from the teaching of this invention, as should dual or higher mode phones (e.g., digital/analog or TDMA/CDMA/analog phones). Additionally, the mobile terminal 10 may be capable of operating according to Wireless Fidelity (Wi-Fi) protocols. It will be appreciated that the above protocols are merely for purposes of example and the mobile terminal 10 is not limited to operation in accordance with the listed example protocols. The mobile terminal 10 may operate with any current or future wireless data technology protocols.

It is understood that the controller 20 may comprise the circuitry required for implementing audio and logic functions of the mobile terminal 10. For example, the controller 20 may be a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 22a, an internal data modem (DM) 22b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

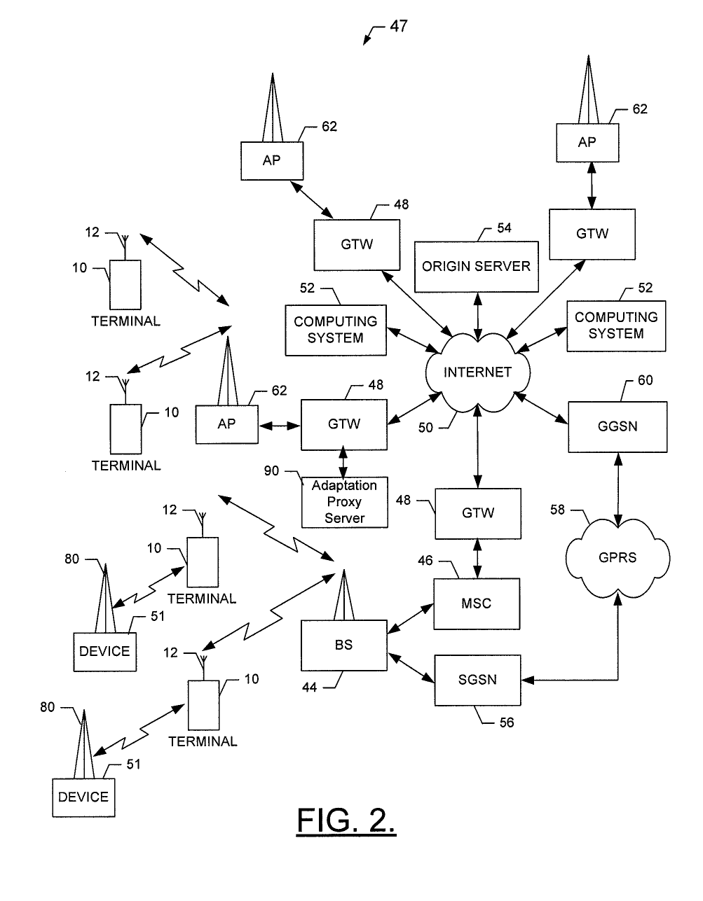

Referring now to FIG. 2, an illustration of one type of system that could support communications to and from an electronic device, such as the mobile terminal of FIG. 1, is provided by way of example, but not of limitation. As shown, one or more mobile terminals 10 may each include an antenna 12 for transmitting signals to and for receiving signals from a base site or base station (BS) 44. The base station 44 may be a part of one or more cellular or mobile networks each of which may comprise elements required to operate the network, such as a mobile switching center (MSC) 46. As well known to those skilled in the art, the mobile network may also be referred to as a Base Station/MSC/Interworking function (BMI). In operation, the MSC 46 may be capable of routing calls to and from the mobile terminal 10 when the mobile terminal 10 is making and receiving calls. The MSC 46 may also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In one typical embodiment, however, the MSC 46 may be coupled to a GTW 48, and the GTW 48 may be coupled to a WAN, such as the Internet 50. In turn, devices such as processing elements (e.g., personal computers, server computers or the like) may be coupled to the mobile terminal 10 via the Internet 50. For example, as explained below, the processing elements may include one or more processing elements associated with a computing system 52 (two shown in FIG. 2), origin server 54 (one shown in FIG. 2) or the like, as described below.

As shown in FIG. 2, the BS 44 may also be coupled to a signaling GPRS (General Packet Radio Service) support node (SGSN) 56. As known to those skilled in the art, the SGSN 56 may be capable of performing functions similar to the MSC 46 for packet switched services. The SGSN 56, like the MSC 46, may be coupled to a data network, such as the Internet 50. The SGSN 56 may be directly coupled to the data network. Alternatively, the SGSN 56 may be coupled to a packet-switched core network, such as a GPRS core network 58. The packet-switched core network may then be coupled to another GTW 48, such as a GTW GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown in FIG. 2 and described herein, it should be appreciated that electronic devices, such as the mobile terminal 10, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

As depicted in FIG. 2, the mobile terminal 10 may further be coupled to one or more wireless access points (APs) 62. The APs 62 may comprise access points configured to communicate with the mobile terminal 10 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 and/or origin server 54 across the Internet 50, the mobile terminal 10, computing system 52 and origin server 54 may be coupled to one another and communicate in accordance with, for example, RF, BT, IrDA or any of a number of different wireline or wireless communication techniques, including LAN, WLAN, WIMAX, Wireless Fidelity (Wi-Fi), Wibree™ and/or UWB techniques. One or more of the computing systems 52 may additionally, or alternatively, include a removable memory capable of storing content, which can thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, Wibree™, Wi-Fi, WLAN, WiMAX and/or UWB techniques. In this regard, the mobile terminal 10 may be capable of communicating with other devices via short-range communication techniques. For instance, the mobile terminal 10 may be in wireless short-range communication with one or more devices 51 that are equipped with a short-range communication transceiver 80. The electronic devices 51 can comprise any of a number of different devices and transponders capable of transmitting and/or receiving data in accordance with any of a number of different short-range communication techniques including but not limited to Bluetooth™, RFID, IR, WLAN, Infrared Data Association (IrDA) or the like. The electronic device 51 may include any of a number of different mobile or stationary devices, including other mobile terminals, wireless accessories, appliances, portable digital assistants (PDAs), pagers, laptop computers, motion sensors, light switches and other types of electronic devices.

For purposes of the ensuing description of embodiments of the invention, embodiments of the invention will be discussed in conjunction with the mobile terminal 10 of FIG. 1 as well as the system of FIG. 2. It will be appreciated, however, that embodiments of the invention may be utilized to enhance the web browsing experience for users of devices other than a mobile terminal 10, as embodiments of the invention may enhance the web browsing experience of users of any device communicating over a network whose resources may be limited or constrained or where it may otherwise be desirable to fetch stripped down versions of web pages with reduced data size when possible, such as in instances in which the user is charged based on the quantity of data transmitted to the user or in instances in which the time required to download the data can vary dramatically based upon the quantity of the data. Furthermore, embodiments of the invention are not limited to communicating over the system of FIG. 2 and may be embodied in systems using other devices or other modes of communication between devices. Also, as used herein, the term “exemplary” merely means an example and should not be construed to refer to a preferred embodiment. The terms “adapted” and “transcoded” may be used interchangeably when used to refer to a transcoded version of a web page or the transcoding process.

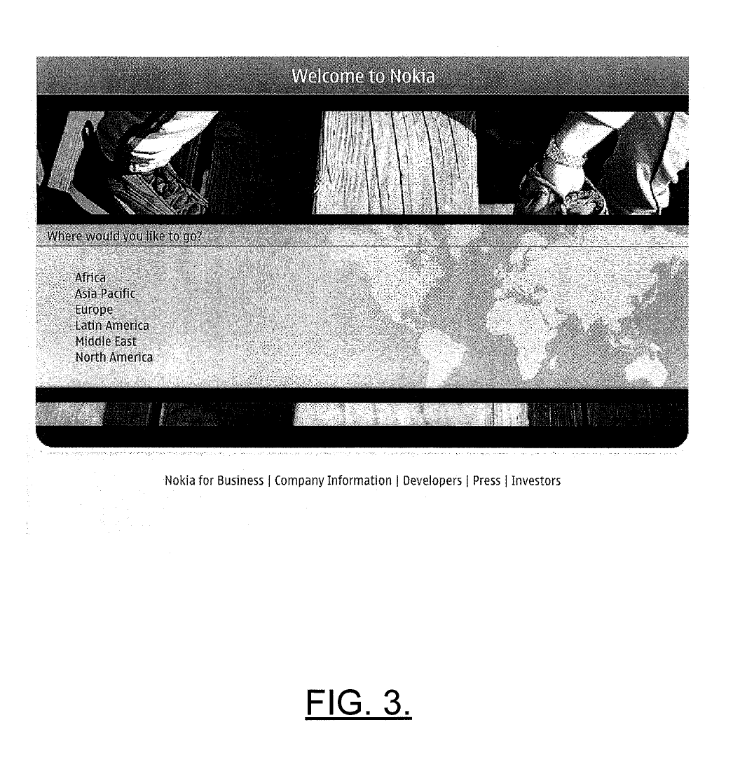

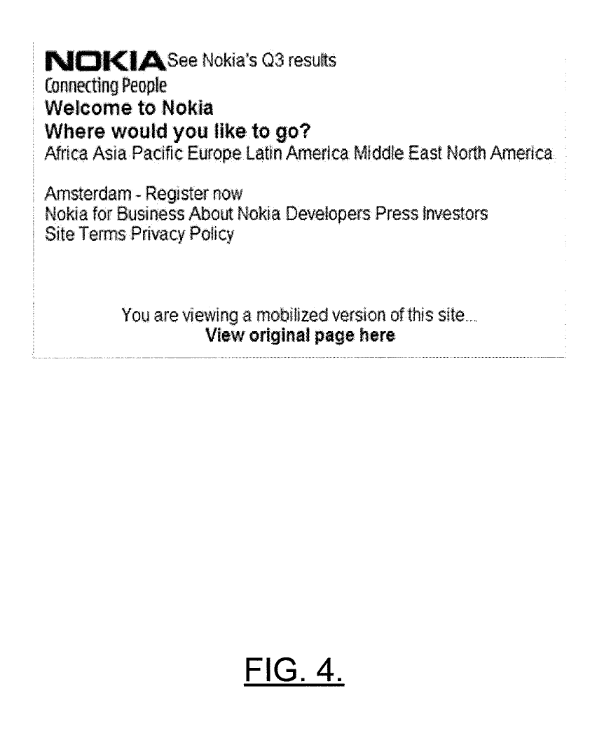

FIG. 3 illustrates a full, original web page as may be displayed on a standard desktop web browser or on a mobile device running a full web browser. As may be seen, the page contains many graphical elements and a relatively complex layout. FIG. 4 illustrates the same web page after it has been transcoded to generate an adapted version which may be optimally fetched and displayed by a mobile device. As may be seen, the adapted version has been stripped of many of the images contained in the original web page and much of the layout has been lost.

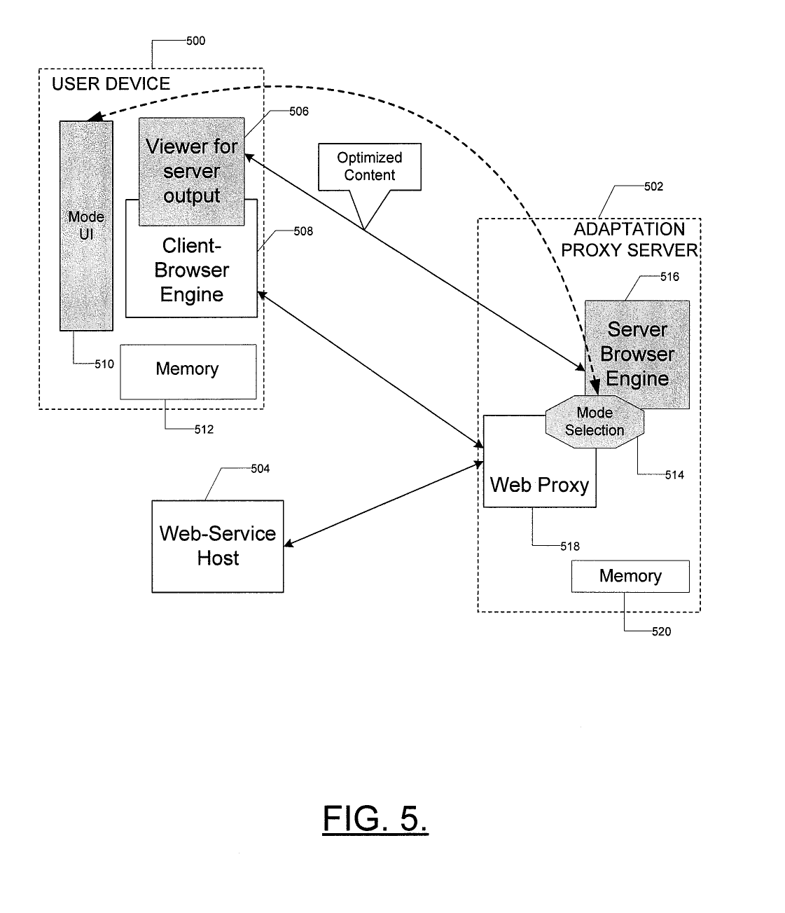

Referring now to FIG. 5, a system according to an exemplary embodiment of the invention for delivering web content to a device is illustrated. The system may comprise a user device 500, which may be a mobile terminal such as the mobile terminal 10, an adaptation proxy server 502, and a web-service host 504. The user device 500 may include a mode user interface 510. The mode user interface 510 may be embodied in any device or means embodied in either hardware, software, or a combination of hardware and software. The mode user interface 510 may, for example, be embodied in software that may be executed on or otherwise controlled by the processor, such as for example, the controller 20 of the mobile terminal 10. The mode user interface 510 may be configured to receive data comprising an indication of what version, also referred to as a “mode” of the current web page was fetched over a network communication link, such as any of the communication links shown in the system of FIG. 2, and to provide a user of the device 500 an indication of which mode of the current web page is displayed. This indication may be by any variety of means, such as for example, a visual indication displayed on the display 28 of a mobile terminal 10. Embodiments of the invention allow for two potential modes of display. The first is the display of the full version of a web page, also referred to as “full mode,” which may result in the fetching and displaying of the full original web page, such as that depicted in FIG. 3. The second is the display of an adapted version of a web page, also referred to as “turbo mode,” which may result in the fetching and displaying of a transcoded and stripped down version of the full web page, such as that depicted in FIG. 4.

In an exemplary embodiment, the mode user interface 510 may further be configured to allow a user to select a preferred mode for display. The user selected mode of preferred display may be locked so that all subsequent webpage fetches result in the fetching and display of web pages in the preferred mode. Alternatively, the user selected mode of preferred display may be limited to the current web page and a user may make similar selections in conjunction with the fetching and display of subsequent web pages. In addition, the mode user interface 510 may be further configured so that if a currently displayed web page is displayed in a mode that is not suitable, such as if an adapted version of the web page is displayed and it is non-functional, a user of the device 500 may request that the alternative version of the web page, such as the full web page, be fetched and displayed in response to the request. The mode user interface 510 may be configured to transmit a user selected mode over a network communication link, such as any of the communication links shown in the system of FIG. 2

The user device 500 may also include a viewer for server output (“viewer”) 506. The viewer 506 may be embodied in any device or means embodied in either hardware, software, or a combination of hardware and software. The viewer 506 may, for example, be embodied in software that may be executed on or otherwise controlled by the processor, such as for example, the controller 20 of the mobile terminal 10. The viewer 506 may be configured to receive data comprising an adapted version of a web page over a network communication link, such as any of the communication links shown in the system of FIG. 2, when the system is operating in turbo mode and to display the adapted version of the web page, so that it is viewable by a user of the device 500 on a display connected to the device 500, such as the display 28 of a mobile terminal 10.

The user device 500 may further include a client-browser engine (“client-browser”) 508. The client-browser 508 may be embodied in any device or means embodied in either hardware, software, or a combination of hardware and software. The client-browser 508 may, for example, be embodied in software that may be executed on or otherwise controlled by the processor, such as for example, the controller 20 of the mobile terminal 10. The client-browser 508 may be configured to receive data comprising the full original version of a web page over a network communication link, such as any of the communication links shown in the system of FIG. 2, when the system is operating in full mode and to display the full version of the web page, so that it is viewable by a user of the device 500 on a display connected to the device 500, such as the display 28 of a mobile terminal 10.

Although in some embodiments, adapted versions of web pages received by the user device 500 may be in a proprietary or other format not supported by the client-browser 508, in alternative embodiments, received adapted versions of web pages may be formatted using a format supported by the client-browser 508. In such alternative embodiments, the user device 500 need not include a separate viewer for server output 506 and the client-browser engine 508 may display adapted web pages as well as full unmodified web pages.

In an exemplary embodiment, the mode user interface 510 may have access to memory 512. The memory 512 may be embodied in the user device 500, such as the non-volatile memory 42 of a mobile terminal 10. The embodiment of the invention illustrated in FIG. 5, however, is just one embodiment and the invention is not limited to embodiments in which the memory 512 is located within the device 500. In alternative embodiments, the memory 512 may be embodied in a device remote from the user device 500, such as in the adaptation proxy server 502 or in any of the devices depicted in the system of FIG. 2. The memory 512 may store a user's preferred mode in association with a web page URL for each web page that has been fetched. While in the above described exemplary embodiment the memory 512 may store a mode in association with a web page URL only if the user selected a preferred mode for the particular web page URL, in an alternate embodiment the memory 512 may store the last mode of the web page fetched in association with previously fetched web page URLs for which the user did not select a preferred mode. In embodiments including memory 512, the mode user interface 510 may be further configured to access the memory 512 upon a user request for a web page and determine if any mode is stored in association with a the URL of the requested web page and if so to communicate the stored mode as a selected choice to a remote server device, such as the adaptation proxy server 502.

In addition to the device 500, the system may include a computing device, such as an adaptation proxy server 502. The adaptation proxy server 502 generally includes a processor and in exemplary embodiments may be embodied on any device in the system of FIG. 2, such as for example, a standalone server in the operator network such as the adaptation proxy server 90, the origin server 54, or as a feature of the gateway 48. In alternative embodiments, the adaptation proxy server 502 may be hosted elsewhere in the Internet, such as for example, on a computing device maintained or otherwise hosted by a web browser manufacturer. In such an alternative embodiment, all queries or other web page requests may be routed through that hosted adaptation proxy server 502 by default. However, if a user of the user device 500 selects to receive full versions of all requested web pages as a permanent mode of preferred display then queries may not be routed through the adaptation proxy server 502 since adaptation will never be performed.

The adaptation proxy server may include a web proxy 518. The web proxy 518 may be embodied in any device or means embodied in either hardware, software, or a combination of hardware and software. The web proxy 518 may, for example, be embodied in software that may be executed on or otherwise controlled by a processor. The web proxy 518 may be configured to receive a request to fetch a web page from the client-browser 508 of the user device 500 and to then retrieve that web page from a web-service host 504. The web-service host 504 may be a remote computing device executing a server application configured to serve a web page stored in memory thereon to remote network devices in response to a request. The web-service host 504 may be any of the devices of the system of FIG. 2. Alternatively, the web proxy may obtain the web page from a local cache if the web page had been recently requested.

The adaptation proxy server 502 may further include means, such as a mode selection module 514, for determining the mode of the web page to be provided to the user device 500. The mode selection module 514 may be embodied in any device or means embodied in either hardware, software, or a combination of hardware and software. The mode selection module 514 may, for example, be embodied in software that may be executed on or otherwise controlled by a processor. The mode selection module may be in communication locally with the web proxy 518 and upon receiving data comprising a web page retrieved from a web-service host 504 may determine in which mode the adaptation proxy server 502 should return the requested web page to the user device 500.

This determination may be made by any of several means. In one embodiment, the mode selection module 514 may analyze the page contents of the requested page. In analyzing the page contents of the requested page, the mode selection module 514 may analyze the complexity of the page layout, the data size of the requested page in its original form, as well as whether the requested page contains any dynamic elements which would render the page non-functional if they were removed through transcoding. If the mode selection module 514 determines that the original version of the requested page is sizeable in terms of data transmission requirements (such as by being of a size or complexity that would likely require the transmission of more than a predefined amount of data or being of a size or complexity that would likely require more than a predefined amount of time to load, for which the predefined amount of time may be an estimated time for adapting and loading an adapted version of the web page) but that it does not possess a complex layout or dynamic elements which would render the page non-functional if transcoded, then the mode selection module 514 may select turbo mode for delivery of the content. If, however, the mode selection module 514 determines that the original version of the requested page is not sizeable and thus a user of device 500 would not experience a high latency between making the fetch request and subsequent display and as such that adapting the web page would be a waste of computing resources (such as by being of a size or complexity that would likely require the transmission of less than a predefined amount of data), the mode selection module 514 may select full mode for delivery of the web content. The mode selection module 514 may also select full mode for delivery of the requested web content if, for example, the original web page contains dynamic elements such as JavaScript or a complex layout which would not display properly if the web page was adapted and thus render an adapted version non-functional.

In an exemplary embodiment, the mode selection module 514 may further be in communication with the mode user interface 510 of the user device 500, such as via a mobile network communications link. As such, the mode selection module 514 may be configured to send an indication of the selected mode to the mode user interface 510 for display at the device 500. The mode selection module 514 may further be configured to make a mode selection based upon an indication of a mode selected or preferred by a user of the device 500, which may be received from the mode user interface 510 in conjunction with a request to fetch a web page. In an exemplary embodiment, such a user selected or preferred mode, if available, may supersede any determination of an appropriate mode made by the mode selection module 514 based upon an analysis of the content of a requested page. As discussed above, in connection with the mode user interface 510, a user selected or preferred mode may comprise either a permanent mode selection by a user, a request for a particular mode limited to a single web page request, or if the requested web page has been viewed on the device 500 previously may comprise a stored user preference for that web page or the mode in which the web page was last viewed. As such, in an exemplary embodiment, the mode selection module 514 may be configured to first determine whether the requested web page has previously been fetched by the device 500. This determination may be made in multiple ways. As previously discussed, a memory 512 on the device 500 may store a list of previously visited URLs in association with a user-expressed preferred mode for that page and/or the last mode in which the page was viewed. As such, the mode user interface 510 may be configured to determine if a mode is associated with a user requested URL from a previous viewing of the requested web page and if so send the associated mode to the mode selection module 514, which may then select the mode sent by the mode user interface 510 as the appropriate mode for display in response to the current fetch request. If, however, the mode selection module 514 logically determines, such as through analyzing the content of a requested web page as described above, that the received selected or preferred mode is not optimal, such as if the requested web page may not display or operate properly in the received selected mode, the mode selection module 514 may be configured to communicate an indication that the selected mode may be improper along with a prompt to replace the currently displayed version with an alternative version to the mode user interface 510. While the above discussion discusses the list of previously viewed web pages and associated modes being stored on the device 500, embodiments of the invention are not so limited and as such the list may be stored on memory local to the adaptation proxy server 502, such as memory 520, or on memory of another device, such as a device of the system of FIG. 2 with which the mode selection module 514 may communicate.

The mode selection module 514 may be configured to communicate with the web proxy 518 when the mode selection module 514 determines that a requested page should be sent and viewed in full mode and to instruct means, such as the web proxy 518, to send data comprising the full, unmodified version of the requested web page to the client-browser 508 of the device 500. As such, the web proxy 518 may be configured to communicate the data over a network link, such as over one of the network links of the system of FIG. 2 according to the standards a common internet protocol such as, for example, HTTP or HTTPS.

The mode selection module 514 may further be configured to communicate with means, such as a server browser engine (“server browser”) 516, if the mode selection module 514 determines that the requested page should be sent and viewed in turbo mode and to instruct the server browser 516 to transcode the requested web page and send the transcoded version to the device 500. The server browser 516 may be embodied in any device or means embodied in either hardware, software, or a combination of hardware and software. The server browser 516 may, for example, be embodied in software that may be executed on or otherwise controlled by a processor. The server browser 516 may be configured to receive data comprising an original full web page, such as from the web proxy 518. The server browser 516 may further be configured to transcode the full web page to generate an adapted version, such as the adapted page illustrated in FIG. 4 in response to the selection of turbo mode by the mode selection module 514. The server browser 516 may be in communication with the viewer 506 of the device 500 over means, such as a mobile communications network link, such as a link of the system of FIG. 2 and may send adapted web pages to the viewer 506 over a network link. Such communication may be handled in any number of protocols, including standard internet protocols such as HTTP, or in other protocols common to mobile communications networks, which may result in more rapid data transmission. Although the server browser 516 is illustrated for purposes of example as a component of the adaptation proxy server 502, embodiments of the invention are not so limited and the server browser engine 516 may be embodied on a remote device, such as any of the devices of the system of FIG. 2 and may be in communication with components of the adaptation server 502 over a network link, such as any link of the system of FIG. 2.

In an exemplary embodiment, the adaptation proxy server 502 may include a memory 520. Although discussed for purposes of example as being local to the adaptation proxy server 502, embodiments of the invention are not so limited and the memory 520 may be located in a device remote from the adaptation proxy server 502, such as any of the devices of the system of FIG. 2. The mode selection module 514 may be in communication with the memory 520 and any time the mode selection module 514 receives a user-selected or preferred mode for a web page from the mode user interface 510, the mode selection module 514 may be further configured to store the selected or preferred mode in association with the web page's URL in memory 520. The preferences of a plurality of users for a plurality of web pages may be aggregated and stored in memory 520 in association with respective web page URLs. As such, the mode selection module 514 may be configured to access the memory 520 and look up the URL for an incoming web page fetch request to determine if there is a preferred mode for the web page from user aggregated preferences stored thereon. The mode selection module 514 may be further configured to use the aggregated preference result to determine the mode in which the requested web page should be sent.

Although the embodiment illustrated in FIG. 5 illustrates the mode user interface 510 as being a component of or otherwise implemented by the user device 500, in an alternative embodiment the functionality of the mode user interface 510 may be a component of or otherwise implemented by the adaptation proxy server 502 or by some other remote network computing device. In such an alternative embodiment, the adaptation proxy server 502 may provide for an indication of which mode of the current web page is displayed as well as for selection of a preferred or alternative mode to view the web page by adding controls to the HTML of the full or adapted web page sent to the user device 500. These controls may, for example, be implemented as a tool bar along the top or side edge of the web page and allow for a user to ‘click’ a button indicating a desire to select a preferred mode for the web page or to request that the alternative version of the web page be transmitted to the user device 500. Further, in this alternative embodiment, the memory 520 of the adaptation proxy server 502 may store all user-specific settings and preferences in association with each individual user of a user device 500.

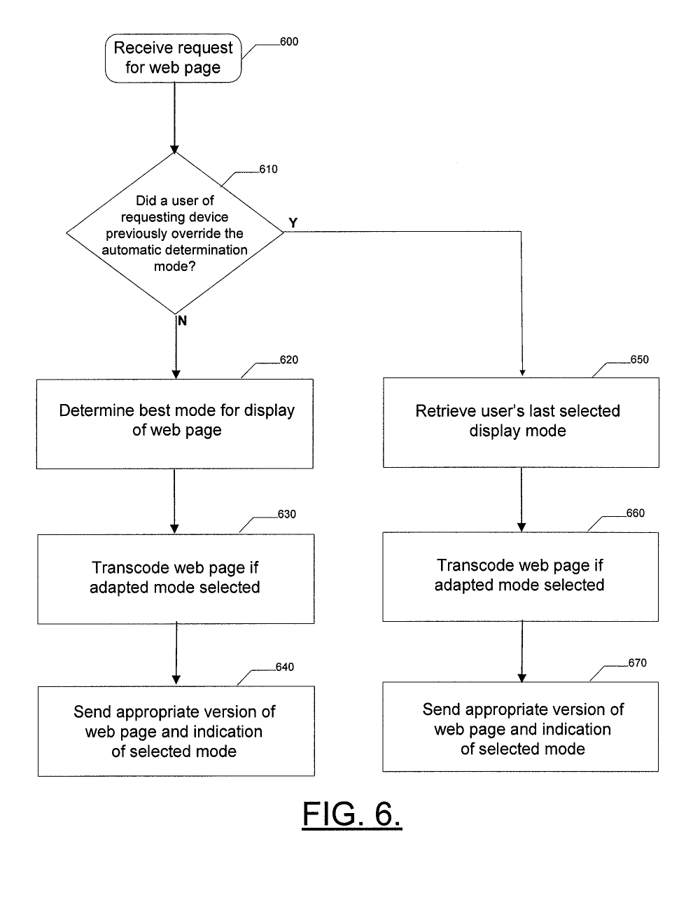

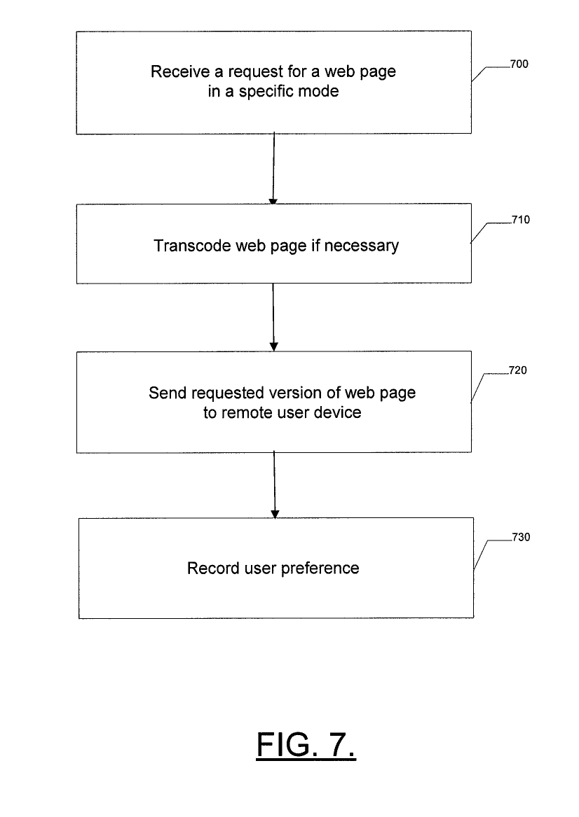

FIGS. 6 and 7 are flowcharts of methods and computer program products according to an exemplary embodiment of the invention. It will be understood that each block or step of the flowcharts, and combinations of blocks in the flowcharts may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a processor of a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one embodiment of a method of delivering web content to a user device as depicted in FIG. 6 may include receiving a request for a web page, such as that illustrated in FIG. 3, at operation 600. Next, at operation 610, a hardware or software component, such as, for example, the mode selection module 514 of the adaptation proxy server 502, may determine whether a user of the requesting device previously overrode the automatic determination mode. A user override of the automatic determination mode may comprise overriding the automatic determination mode and selecting a preferred display mode for only a particular web page or globally overriding the automatic determination mode and selecting a preferred display mode for all subsequently requested web pages. Although, the determination at operation 610 is illustrated for purposes of example in an exemplary embodiment, embodiments of the invention are not so limited and this operation may be bypassed or excluded in alternative embodiments. If at operation 610 it is determined that the a user of the requesting device has not previously overridden the automatic determination mode (again, the override may be limited to the requested web page or may be a global override) or in embodiments in which operation 610 is not executed, the mode selection module 514 may automatically determine the best mode for display of the requested web page, at operation 620. This determination may be based upon any of the means discussed above in connection with the system of FIG. 5. If adapted (also referred to as “turbo”) mode is selected, then the server browser engine 516 may transcode the web page to generate an adapted version, such as that illustrated in FIG. 4, at operation 630. Next, at operation 640, the adaptation proxy server 502 may send data comprising the appropriate version of the web page and an indication of the selected mode.

If at operation 610, it is determined that a user of the requesting device has previously overridden the automatic determination mode, then the mode selection module 514 may retrieve the requesting device user's last selected display mode, at operation 650. As discussed above, the last selected display mode may comprise either a preferred mode for the requested web page previously specified by the user of the requesting device or may be a globally selected preferred display mode for all requested web pages. If adapted (also referred to as “turbo”) mode was the user's last selected display mode, then the server browser engine 516 may transcode the web page to generate an adapted version, such as that illustrated in FIG. 6, at operation 660. Next, at operation 670, the adaptation proxy server 502 may send data comprising the appropriate version of the web page and an indication of the selected mode.

Referring now to FIG. 7, a flowchart according to an exemplary method for allowing a user to request a web page be delivered in a specific mode and aggregating user preferences is illustrated. The method may comprise the mode selection module 514 receiving a request from the mode user interface 510 for a web page in a specific mode, at operation 700. This request may be made, for example, after a user of the device 500 has received a web page in a mode which may have been previously selected by the mode selection module 514 in response to a previous request for the same web page, but the previously sent version of the web page did not display or function properly on the device 500. If the request was for the web page to be delivered in adapted mode, then the web page may be transcoded, such as by the server browser engine 516, at operation 710. Next, at operation 720, the adaptation proxy server 502 may send the requested version of the web page to the device 500. The mode selection module 514 may then, at operation 730, record the requested mode as a user preference, such as in memory 520 wherein the preference may be stored in association with the URL of the requested web page and the mode preferences of a plurality of users for that URL may be aggregated.

In exemplary embodiments, this method for allowing a user to request a web page in a specific mode and aggregating user preferences as illustrated in FIG. 7 is only carried out when a user requests a specific mode only for a particular web page URL rather than specifying a global preference for all web pages. As such, an exemplary system may distinguish between a request for a single web page in a specific mode and a global request for a specific mode. In this regard, a system implementing the exemplary method may intelligently learn from users who request a particular web page be displayed in a particular mode for optimum display purposes. The aggregate preferences for a particular web page URL may then be used in determining a best mode for display of the web page when the URL is requested by a user operating a device using automatic determination mode for the requested web page. (Refer back to operations 610-620 of FIG. 6) Therefore, in exemplary embodiments a user's selection of a global preference to receive all requested web pages in a particular mode is not aggregated because the request does not represent an intelligent determination of a best mode for viewing every web page that may be requested and as such should not be considered when executing operation 620 of FIG. 6.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, embodiments of the invention provide several advantages for mobile device users who use their mobile devices to browse the web as well as mobile communications service providers who provide mobile web browsing services. From the mobile device user perspective, embodiments of the invention may result in the automatic delivery of requested web content in a desirable format based upon factors such as aggregated preferences of a plurality of device users, a prior expressed preference of the user, the size of the requested web page, and/or the complexity of the requested web page as it relates to the potential impact on functionality of a transcoded version without requiring user foresight or otherwise imposing a burden on a user of a mobile device to participate in the mode selection process. From the perspective of a mobile communications service provider, embodiments of the invention may result in reduced use of network bandwidth as web pages may be transcoded to generate smaller adapted versions when possible. Network bandwidth usage may further be reduced by potentially reducing scenarios in which a device user requests a web page only to discover that the delivered version of the web page is not functional or viewable on the mobile device and then must request the web page be fetched in another mode, thus requiring data comprising the same web page to be sent twice over the network. Service providers and device manufactures may also benefit from the implementation of embodiments of the invention because users may automatically have a better web browsing experience and as such may be more satisfied with their current mobile device and service provider.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
determining whether an original web page is to be adapted or is to be viewed in its original form;
transcoding the original web page to generate a transcoded version of the web page if it is determined that the web page is to be adapted; and
sending data comprising either the original web page or the transcoded version to a remote device.

2. A method according to claim 1, wherein determining whether an original web page is to be adapted or is to be viewed in its original form further comprises one or more of receiving a preference associated with the remote device, determining if the original web page will require more than a predefined time to load in its original form and would still be functional if transcoded, determining if the original web page will require the transmission of more than a predefined amount of data if transmitted in its original form and would still be functional if transcoded, determining if the original web page will require less than a predefined time to load in its original form, determining if the original web page will require the transmission of less than a predefined amount of data if transmitted in its original form, or determining if the original web page contains dynamic or other content that will not function properly if transcoded.

3. A method according to claim 1, wherein determining whether an original web page is to be adapted or is to be viewed in its original form further comprises determining whether the remote device has previously selected a preferred version for the web page, and if so selecting the version of the web page last selected by the remote device.

4. A method according to claim 1, further comprising recording a user preference for either the original web page or the transcoded version of the web page and aggregating the preferences of a plurality of users who have previously selected a preferred version of the web page.

5. A method according to claim 4, wherein determining whether an original web page is to be adapted or is to be viewed in its original form further comprises determining a preferred version of the web page from the aggregated preferences of the plurality of users.

6. A method according to claim 1, further comprising sending to the remote device an indication of which version of the web page was sent.

7. A method according to claim 1, further comprising:
receiving an indication of a preferred version of the web page from the remote device, wherein the indication indicates a version of the web page other than that which was previously sent;
sending data comprising the indicated version of the web page, wherein if the indicated version of the web page is the transcoded version sending data comprising the indicated version of the web page further comprises transcoding the original web page to generate a transcoded version of the web page; and
recording the indicated version of the web page in association with the respective web page.

8. A computer program product comprising at least one computer-readable storage medium having computer-readable program code portions stored therein, the computer-readable program code portions comprising:
a first executable portion for determining whether an original web page is to be adapted or is to be viewed in its original form;
a second executable portion for transcoding the original web page to generate a transcoded version of the web page if it is determined that the web page is to be adapted; and
a third executable portion for sending data comprising either the original web page or the transcoded version to a remote device.

9. A computer program product according to claim 8, wherein the first executable portion includes instructions for determining whether an original web page is to be adapted or is to be viewed in its original form further comprises instructions for one or more of receiving a preference associated with the remote device, determining if the original web page will require more than a predefined time to load in its original form and would still be functional if transcoded, determining if the original web page will require the transmission of more than a predefined amount of data if transmitted in its original form and would still be functional if transcoded, determining if the original web page will require less than a predefined time to load in its original form, determining if the original web page will require the transmission of less than a predefined amount of data if transmitted in its original form, or determining if the original web page contains dynamic or other content that will not function properly if transcoded.

10. A computer program product according to claim 8, wherein the first executable portion includes instructions for determining whether the remote device has previously selected a preferred version for the web page, and if so selecting the version of the web page last selected by the remote device.

11. A computer program product according to claim 8, further comprising a fourth executable portion for recording a user preference for either the original web page or the transcoded version of the web page and aggregating the preferences of a plurality of users who have previously selected a preferred version of the web page.

12. A computer program product according to claim 11, wherein the first executable portion includes instructions for determining whether an original web page is to be adapted or is to be viewed in its original form based upon an indication of a preferred version of the web page determined from the aggregated preferences of the plurality of users.

13. A computer program product according to claim 8, wherein the third executable portion includes instructions for sending to the remote device an indication of which version of the web page was sent.

14. A computer program product according to claim 8, further comprising:
a fourth executable portion for receiving an indication of a preferred version of the web page from the remote device, wherein the indication indicates a version of the web page other than that which was previously sent;
a fifth executable portion for sending data comprising the indicated version of the web page, wherein if the indicated version of the web page is the transcoded version sending data comprising the indicated version of the web page further comprises transcoding the original web page to generate a transcoded version of the web page; and
a sixth executable portion for recording the indicated version of the web page in association with the respective web page.

15. An apparatus comprising a processor configured to:
determine whether an original web page is to be adapted or is to be viewed in its original form;
transcode the original web page to generate a transcoded version of the web page if it is determined that the web page is to be adapted; and
send data comprising either the original web page or the transcoded version to a remote device.

16. An apparatus according to claim 15, wherein the processor is further configured to determine whether an original web page is to be adapted or is to be viewed in its original form based upon one or more of a preference associated with the remote device, a determination of whether the original web page will require more than a predefined time to load in its original form and would still be functional if transcoded, a determination of whether the original web page will require the transmission of more than a predefined amount of data if transmitted in its original form and would still be functional if transcoded, a determination of whether the original web page will require less than a predefined time to load in its original form, a determination of whether the original web page will require the transmission of less than a predefined amount of data if transmitted in its original form, or a determination of whether the original web page contains dynamic or other content that will not function properly if transcoded.

17. An apparatus according to claim 15, wherein the processor is further configured to determine whether an original web page is to be adapted or is to be viewed in its original form by determining whether the remote device has previously selected a preferred version for the particular web page, and if so to select the version of the web page last selected by the remote device.

18. An apparatus according to claim 15, wherein the processor is further configured to record a user preference for either the original web page or the transcoded version of the web page and aggregate the preferences of a plurality of users who have previously selected a preferred version of the web page.

19. An apparatus according to claim 18, wherein the processor is further configured to determine whether an original web page is to be adapted or is to be viewed in its original form based upon an indication of a preferred version of the web page determined from the aggregated preferences of the plurality of users.

20. An apparatus according to claim 15, wherein the processor is further configured to send to the remote device an indication of which version of the web page was sent.

21. An apparatus according to claim 15, wherein the processor is further configured to:
receive an indication of a preferred version of the web page from the remote device, wherein the indication indicates a version of the web page other than that which was previously sent;
send data comprising the indicated version of the web page, wherein if the indicated version of the web page is the transcoded version the processor is further configured to transcode the original web page to generate a transcoded version of the web page; and
record the indicated version of the web page in association with the respective web page.

22. A system comprising
a computing device configured to receive a request for a web page from a remote device and to determine whether to send either an original web page or a transcoded version of the web page to a remote device, wherein the computing device is further configured to transcode the original web page to generate a transcoded version of the web page if the computing device determines that a transcoded version of the web page is acceptable to the remote device; and
a device running a web browser application configured to send a request for a web page to a computing device and to receive one or both of the original web page or the transcoded version of the web page.

23. An apparatus comprising:
means for determining whether an original web page is to be adapted or is to be viewed in its original form;
means for transcoding the original web page to generate a transcoded version of the web page if it is determined that the web page is to be adapted; and
means for sending data comprising either the original web page or the transcoded version to a remote device.
